(19) United States
(12) Patent Application Publication
(10) Pub. No.: US 2006/0289411 A1
(43) Pub. Date: Dec. 28, 2006

(54) LASER SYSTEM WITH MULTIPLE OPERATING MODES AND WORK STATION USING SAME

(75) Inventors: Jerry Chang, San Jose, CA (US); Peter Bull, San Jose, CA (US); Luther T. Nieh, Redwood City, CA (US)

Correspondence Address: HAYNES BEFFEL & WOLFELD LLP, P O BOX 366, HALF MOON BAY, CA, 94019, US

(73) Assignee: NEW WAVE RESEARCH, Fremont, CA (US)

(21) Appl. No.: 11/426,266

(22) Filed: Jun. 23, 2006

Related U.S. Application Data
(60) Provisional application No. 60/694,010, filed on Jun. 24, 2005.

(51) Int. Cl. B23K 26/06; G06F 19/00

(52) U.S. Cl. 219/121.73; 700/166

(57) ABSTRACT

A method for manufacturing applied to workpieces, such as large flat-panel liquid crystal displays (LCDs) and the like, including identifying and classifying targets on the workpiece, mounting workpiece on a stage, and controlling a laser to generate pulse of light on a single beam line that are adapted to the classification of the target. The laser includes a short pulse mode and a long pulse mode, and provides selectable wavelengths, which are adapted to particular operations on the target. The pulses of light are delivered in both of the first and second modes on the single beam line through an optical system to the targets on the workpiece.

### REFERENCE TO RELATED APPLICATION

The present application claims the benefit of Provisional U.S. Patent Application No. 60/694,010, entitled SWITCHABLE LONG PULSE/SHORT PULSE LASER, filed 24 Jun. 2005, invented by Chang et al.

### BACKGROUND OF THE INVENTION

1. Field of the Invention

The present invention relates to multimode laser systems and to such systems deployed in workstations used in manufacturing.

2. Description of Related Art

Lasers have been used to perform trimming processes on workpieces to remove extra materials. Lasers have also been used to perform welding processes to attach two interfaces together. Unfortunately, the laser that trims materials effectively usually has shorter pulse width, which does not weld efficiently. To perform welding processes, the laser pulse width is preferred to be long to avoid laser ablation. Johnson et al., U.S. Pat. No. 4,930,901 proposes modulating a laser beam to control the magnitude of a spike in power caused by Q-switching, in order to apply different peak powers for a “lead bonding mode” and a “lead severing mode.” In both modes however, a leading spike in energy causes removal of material. Leong et al., U.S. Pat. No. 5,611,946 describes a multi-wavelength system adaptable for multiple uses in manufacturing.

For a laser system to perform both processes which avoid removal of material, and processes with ablate material effectively, two lasers have been required in prior art systems. This arrangement needs a more complicated optical system to integrate two sets of laser beam delivery optics together. The complex optics could create reliability issues. Furthermore, a two laser system could be bulkier and more costly to build.

It is desirable to provide a manufacturing method using a single multimode laser, and a laser which can be operated in multiple modes and adapted for use in a workstation for laser repair operations.

### SUMMARY OF THE INVENTION

The present invention provides a method for manufacturing applied to workpieces, such as large flat-panel liquid crystal displays (LCDs) and the like. These workpieces suffer a variety of defects during manufacture which can be repaired using pulsed laser light adapted for repair of the particular defect. The method includes identifying and classifying targets on the workpiece, mounting workpiece on a stage, and controlling a laser to generate pulses of light on a single beam line, where the pulses are adapted to the classification of the target. The laser includes a first pulse mode and a second pulse mode, where the pulses in the first pulse mode had a first pulse width and peak energy, and in the second pulse mode had a second pulse width and peak energy which are adapted to particular operations on the target. The pulses of light are delivered in both of the first and second modes on a single beam line through an optical system to the targets on the workpiece.

For an embodiment described herein, the first pulse mode comprises a Q-switched mode producing narrow pulse width and high peak energies, and the second pulse mode comprises a non Q-switched mode, producing a broader pulse width based on the application of pump energy to the gain medium, with relatively lower peak energies. The method includes controlling a laser to operate in the Q-switched and non Q-switched modes.

Embodiments are described that apply an optical system including a nonlinear optic causing harmonic generation, and optical elements for selecting an output wavelength from among the fundamental wavelength and harmonic wavelength. The controlling step of the manufacturing process includes operating a mechanism controlling the optical elements to select output wavelength, in addition to the selection of the first and second pulse modes.

In a method for manufacturing as described herein, a magnified image of the target taken along the single beam line, on which the pulses of laser light are delivered to the target, is displayed on a computer terminal.

Technology is described herein for displaying magnified images of spots on the workpiece on a computer workstation, and providing a graphical interface for positioning the spots on the targets, selecting the first pulse mode and the second pulse mode, selecting an output wavelength, selecting a pulse repetition rate, selecting a number of pulses, and for causing delivery of the pulses to the spots.

A laser system and workstation employing the laser system are described as well. The laser system includes a laser that supplies an output beam. The laser has a resonant cavity comprising a gain medium and a Q-switch. A pump energy source is coupled to the gain medium and a Q-switch controller is coupled to the Q-switch. The Q-switch which is switched between a relatively lossy state and a relatively lossless state with controlled timing relative to operation of the pump energy source, in order to induce the first pulse mode and a second pulse mode as described above. An optical system is included with the laser system that delivers the output beam on a single beam line to a target on a workpiece. Embodiments of the optical system including non-linear optic, and optics for selecting an output wavelength. In addition, embodiments of the optical system include a microscope, wherein the single beam line is directed through the microscope to the target. A camera is arranged to generate a magnified image of the target via the single beam line through the optical system. The laser system is deployed with the controller and a computer to form a workstation used in the manufacture of workpieces, like semiconductor wafers and flat panel displays.

Other aspects and advantages of the present invention can be seen on review of the drawings, the detailed description and the claims, which follow.

### BRIEF DESCRIPTION OF THE DRAWINGS

FIG. 1 is a simplified block diagram of a multimode laser system, based on trigger timing control.

FIG. 2 is a timing diagram for a first pulse mode using the system of FIG. 1.

FIG. 3 is a timing diagram for a second pulse mode using the system of FIG. 1.

FIGS. 4A and 4B are a top view and a side view respectively for a layout of a multimode laser and optical system.

FIG. 5 the scheme diagram of a workstation used for LCD repair, including a multimode laser and optical system.

FIG. 6 is an image of a graphical user interface utilized in a system like that of FIG. 5.

FIG. 7 illustrates a defect causing a short circuit which can be repaired in a short pulse mode, as described herein.

FIG. 8 illustrates a method for cutting a trace on a workpiece, using a short pulse mode as described herein.

FIG. 9 illustrates a method for de-passivation of a spot on a workpiece, using a short pulse mode as described herein.

FIG. 10 illustrates a method for curing ink to repair a defect on a workpiece, using a long pulse mode as described herein.

FIGS. 11A and 11B illustrate methods for fusing traces on a workpiece, using a long pulse mode and a combination of a short pulse mode and a long pulse mode as described herein.

FIG. 12 is a simplified flow chart of a method for manufacturing using a multimode laser system.

### DETAILED DESCRIPTION

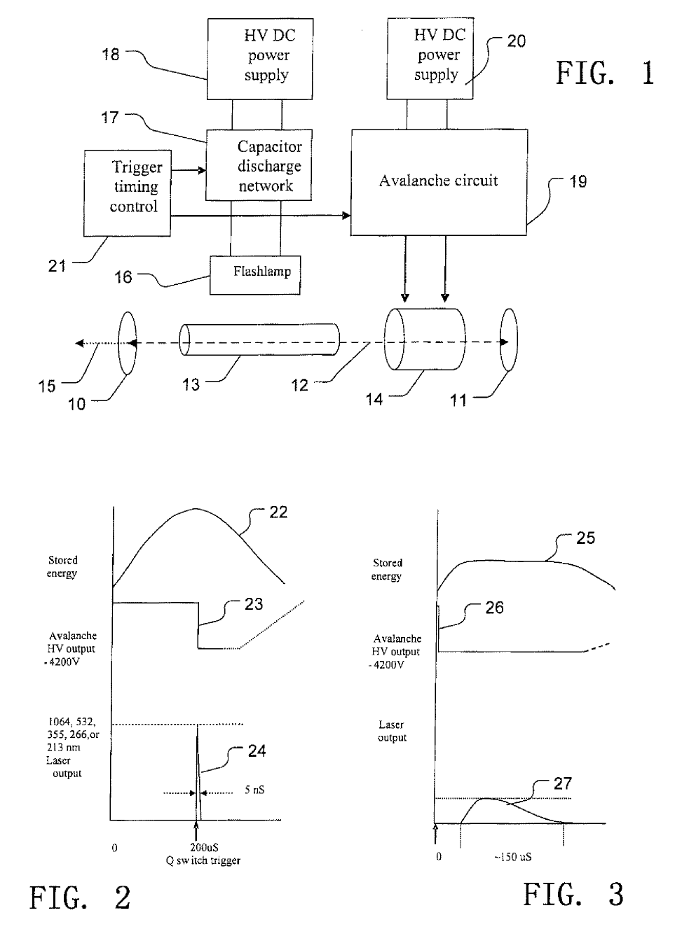

A detailed description of embodiments of the present invention is provided with reference to the FIGS. 1-12, in which FIG. 1 shows a basic structure for a multimode laser, producing a first pulse mode with relatively short pulse widths and high peak energies, and as second pulse mode with relatively long pulse widths and low peak energies.

The laser shown in FIG. 1 includes a front mirror 10 acting as an output coupler and a back mirror 11 which define a resonant path 12 within the a resonant cavity of the laser. A gain medium 13 is included in the resonant path 12. In addition, a Q-switch 14 is placed in the resonant path 12. The Q-switch 14 has a relatively lossy mode which blocks laser oscillation on the resonant path 12, and a relatively lossless mode which allows laser oscillation. A pump energy source, such as flash lamp 16 is coupled with the gain medium 13. The flash lamp 16 is energized by a capacitor discharge network 17 driven by a high-voltage DC power supply 18. On the triggering of the capacitor discharge network 17, the flash lamp 16 generates a pulse of pump energy for the gain medium 13. Laser oscillation occurs, when the Q-switch 14 is in the relatively lossless state, and the population of inverted states in the gain medium 13 reaches a laser threshold. The Q-switch 14 is driven by an avalanche circuit 19, which is in turn coupled to a high-voltage DC power supply 20. The avalanche circuit 19 is used to apply a voltage to the Q-switch 14, in order to switch the Q-switch between the relatively lossless state and the relatively lossy state. A trigger timing control circuit 21 is coupled to the capacitor discharge network 17 and to the avalanche circuit 19, and determines the output pulse shape and other parameters of the output beam, in order to establish at least first and second pulse modes for the laser.

FIG. 2 illustrates the timing for a short pulse mode. As illustrated on trace 22, the pump energy is enabled at time zero and the energy stored in the gain medium increases. On trace 23, the avalanche circuit is enabled to cause a step in the voltage on the Q-switch after about 200 μs is in the illustrated example, switching the Q-switch from the relatively lossy state to the relatively lossless state to enable laser oscillation. The high energy stored in the gain medium discharges quickly, generating a short pulse 24 having a pulse width on the order of 5 ns, and typically between 1 and 10 ns, for example, with a relatively high peak pulse energy. As indicated on FIG. 2, embodiments of the laser can include nonlinear optics (not shown in FIG. 1) which generate harmonics of the fundamental lasing wavelength. Thus, the laser output for an embodiment using the gain medium that comprises Nd:YAG or similar material, can be provided at output wavelength such as the fundamental 1064 nm, or one of the plurality of harmonic wavelengths 532, 355, 266 and 213 nm. In the short pulse mode, the relatively large amount of energy is delivered to the target in a very small time window, reducing heat conduction in the target and preventing material damage near the target caused by the heat transfer. The relatively high peak energy, short duration pulse can be used for ablation of a variety of materials during repair of defects or for other operations on a workpiece being manufactured.

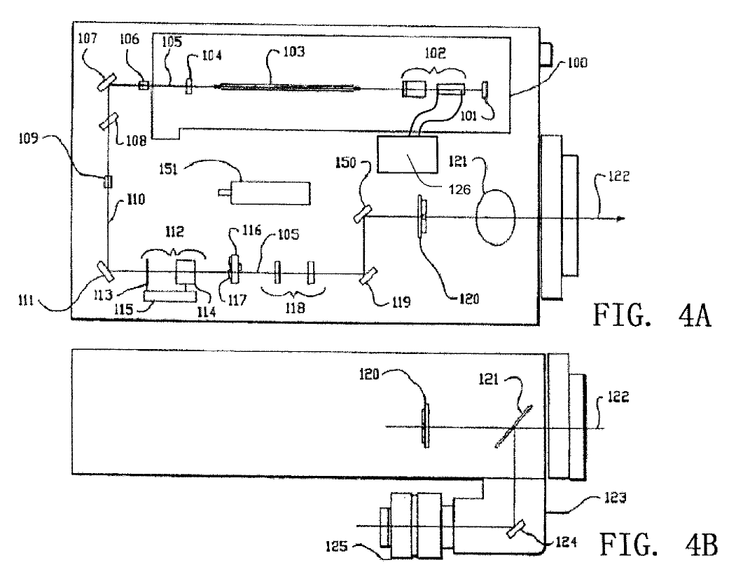

FIG. 3 illustrates the timing for a long pulse mode. As illustrated on trace 25, the pump energy is enabled at time zero and stored in a gain medium 13. On trace 26, the avalanche circuit is enabled to cause a step in the voltage on the Q-switch 14, inducing a relatively lossless state in the resonant cavity before sufficient energy is stored in the gain medium 13 to cause laser oscillation. As the stored energy increases in the gain medium 13, laser oscillation occurs as illustrated on trace 27, with a relatively long pulse, on the order of 150 μs in the embodiment shown, and a relatively low peak energy. The relatively low peak energy, long duration pulse can be used for heating a target material to cause melting, curing and welding for example, without ablation or evaporation of materials.

A layout of the optical design of the laser system in the preferred embodiment is described in FIGS. 4A and 4B. The laser system includes a flash lamp pumped electro-optically Q-switched Nd:YAG laser 100. Alternative systems use other gain media, such as Nd:YVO₄, Nd:YLF and other solid state and non-solid state media that are capable of sufficient stored energy for Q-switching. Alternative systems also use other types of pump energy sources, including arc lamps and laser diode arrays. The laser 100 includes a high reflector 101, electro-optic Q-switch 102, a flash lamp pumped Nd:YAG gain medium 103, and an output coupler 104. Controller 126 is included for controlling timing of the Q-switch 102 and the pump energy source is included, to induce multiple pulse modes as described herein.

The output of the laser 100 is supplied along beam path 105 through a first non-linear crystal 106 for generating the second harmonic of the fundamental output wavelength of the laser 100. In the preferred system, this non-linear crystal is KTP aligned for frequency doubling the 1064 nanometer line of the Nd:YAG laser. Next in the beam path 105 is a high reflecting mirror 107 for the fundamental and second harmonic wavelengths. The mirror 107 directs the beam path 105 at a 90 degree angle through a polarizer 108 to repolarize the fundamental wavelength of the laser 100. The fundamental wavelength is repolarized after the non-linear crystal 106 for more efficient attenuation. The repolarized fundamental frequency and frequency doubled component are then passed along the beam path 105 through a second non-linear crystal 109. The second nonlinear crystal 109, in the preferred system, is used for generating the third harmonic and the fourth harmonic of the fundamental wavelength. In this embodiment, it consists of beta barium borate BBO aligned for either the third or fourth harmonic generation. Other nonlinear crystals may be used as known in the art. In alternative systems, nonlinear elements can be placed intra-cavity.

The fundamental, the second harmonic, and the third or fourth harmonics are then passed along the beam path 110 to a high reflector 111, which is high reflecting at the fundamental wavelength, the second harmonic, the third harmonic, and the fourth harmonic. The high reflector 111 turns the beam 90 degrees through a variable attenuator 112.

The variable attenuator 112 consists of a multiple wavelength wave plate 113 and a calcite polarizer 114. The relative angular position of these two devices is controlled using a mechanism 115 known in the art so as to control attenuation of the laser beam on path 105.

The multiple wavelength wave plate operable at each of the four wavelengths identified must have an optical thickness which is near an odd number of one-half wavelengths of all of the wavelengths of interest. An optical grade crystalline quartz plate having a physical thickness of near 0.77901 millimeters, provides about 180 degrees relative phase retardation of the e- and o- waves for each of the fundamental, the second harmonic, the third harmonic and the fourth harmonic (1064, 532, 355, 266 nm). This corresponds with the 63rd order half-wave at the 266 nanometers of the fourth harmonic. Although the relative phase retardation is not precisely half-wave for all four wavelengths, it is close enough that when combined with a polarizer, an attenuator is formed which is effective at all four. In an embodiment, the attenuator transmission when open is about 100% for the fourth harmonic, about 99.4% for the third harmonic, about 98.6% for the second harmonic and about 89.3% for the fundamental. Other thicknesses for the half-wave plate can be used to achieve similar results, but this is preferred because of the higher transmission in lower power wavelengths of the second, third and fourth harmonics. For instance, a thickness of about 0.0865 millimeters is about 100% transmissive at 266, 89% at 355, 100% at 532 and 62% at 1064. A thickness of about 0.3091 millimeters is about 100% transmissive at 266, 98% at 355, 77% at 532 and 99% at 1064. A thickness of about 0.5564 millimeters is about 100% transmissive at 266, 85% at 355, 87% at 532 and 96% at 1064. A thickness of about 0.9274 millimeters is about 100% transmissive at the fifth harmonic (213 nanometers), about 100% transmissive at 266, 85% at 355 and 88% at 1064, although it is not transmissive at the second harmonic. For single plate half-wave plates, it is desirable to keep the thickness below about 1 millimeter to avoid incurring thermal problems associated with thicker plates.

The attenuated beam is supplied on path 105 out of the variable attenuator 112 through a switchable filter mechanism 116. The switchable filter mechanism mounts a plurality of filters used for selecting the output wavelength of the system. By moving one of the plurality of wavelength selective filters into the beam path, the output wavelength is selected.

The non-linear crystals 109 for generating the third or fourth harmonic cause walkoff of the harmonic wavelengths, so that they are separated from the beam path 105 by an amount of about one-half of a millimeter. This walkoff is critical for the microscope mounted laser system where the output beam must proceed along the same beam line for all the selected wavelengths into the field of view of the microscope.

By tilting filter 117 which is used to select the third or fourth harmonic wavelengths, this walkoff is corrected. Thus, the third or fourth harmonic wavelengths, and the other wavelengths are supplied along the beam path 105 in alignment, independent of which wavelength is selected. In an alternative system one could tilt the filter for the fundamental or second harmonic to realign the beam with the third or fourth harmonic.

The non-linear crystal 106 aligned for second harmonic generation causes negligible walkoff. Thus, the non-linear crystal 109 is primarily responsible for the walkoff which must be corrected by the switchable optics 116, using tilted colored glass filters which select for the desired output.

Next in the beam path 105 is telescope 118. This telescope is used to expand the beam about three times from about a 3 millimeter cross-section to about a 9 millimeter cross-section. This allows for matching the cross-section of the beam with the controllable X-Y aperture 120 described below. After the telescope 118, the beam is supplied along the path 105 to a high reflector 119, which is reflective of the four selectable output wavelengths. The beam is turned at reflector 119 by 90 degrees to reflector 150. Reflector 150 is reflective at the harmonic wavelengths, and at the second, third, and fourth harmonics of the harmonic wavelengths. Also, it is transmissive at 600 nanometers and above in the embodiment described so that visible light is transmitted from a white light source 151 into the beam line such as a 150 watt white lamp, to act as an aiming beam or a spot marker.

The reflector 150 turns the beam path through an X-Y aperture 120 which is used to form a square or rectangular cross-section for the beam being delivered to the microscope.

The beam passes from X-Y aperture 120 to beam splitter 121. The beam splitter 121 is 50% or more transmissive at all of the four wavelengths selectable by the output system. The output of the laser system is then supplied on the beam line 122 into the microscope optics and on a line perpendicular to the drawing in FIG. 4A to a camera adapter 123, as shown in FIG. 4B. An image from the field of view of the microscope is reflected at beam splitter 121 to mirror 124 in the camera adapter 123. The camera adapter includes a fitting 125 to which a video camera or other imaging system may be coupled to the assembly.

The laser layout illustrated in FIGS. 4A and 4B is capable of providing three selectable output wavelengths with the flip of a switch for a probe station or laser cutter, according to the present invention. By tuning the non-linear crystal 109 to select for either the third or fourth harmonics, the laser system can be adapted to select for fundamental output wavelength in the infrared, the second harmonic in the visible, or the third harmonic in the ultraviolet, or to select for the fundamental output wavelength in the infrared, the second harmonic in the visible, or the fourth harmonic in the ultraviolet.

The variable attenuator 112 and the switchable optics 116 are especially designed to overcome the problems associated with multi-wavelength laser systems which must supply controlled attenuation outputs, on a single beam line with the exacting standards.

Because the optics, including attenuator 112, and high reflectors 111, 119 and 150, work for all four possible wavelengths, the laser system of FIG. 4A can be extended to a four wavelength system by inserting an additional nonlinear crystal in series with crystal 109. Any changes in the walkoff of the beam are compensated by adjusting the tilts of the filters as before.

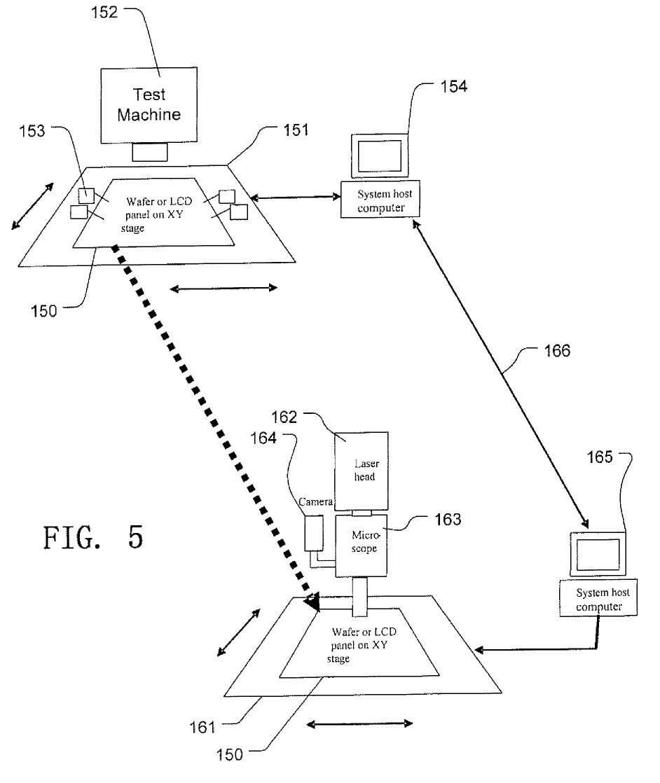

FIG. 5 illustrates deployment of the multimode laser system for manufacturing of workpieces 150, such as semiconductor wafers or LCD panels. As shown in the figure, a workpiece 150 is placed on an X-Y stage 151 of a test machine 152. Probes 153 contact the workpiece 150 and are used for performing tests to locate defects. A system host computer 154 is coupled with the test machine 152, including the X-Y stage 151 and probes 153, and controls the execution of tests to locate, classify and map the defects on the workpiece. The workpiece 150 is then moved to X-Y stage 161 of the multimode laser repair workstation. The multimode laser repair workstation includes a multimode laser head 162 as described above, mounted on a microscope 163 through which the pulses of laser radiation are delivered to targets on the workpiece 150 on the stage 161. A camera 164 is coupled with the microscope, and generates images of targets on the workpiece 150 along the same beam line as the pulses are delivered to the microscope 163. A system host computer 165, which may be the same as computer 154, or another computer which communicates with the computer 154, controls the multimode laser head, the camera, the microscope and of the X-Y stage.

In operation, the computer 154 executes a procedure to locate and classify defects on the workpiece 150, and provides the information gathered to computer 165. The computer 165 controls the stage movement, imaging by the camera and laser firing to perform repair and manufacturing operations on the panel. The output of the laser is configured to execute a recipe according to the classification of the defects being repaired, including selecting the long pulse and short pulse modes, selecting the output wavelength, and other parameters.

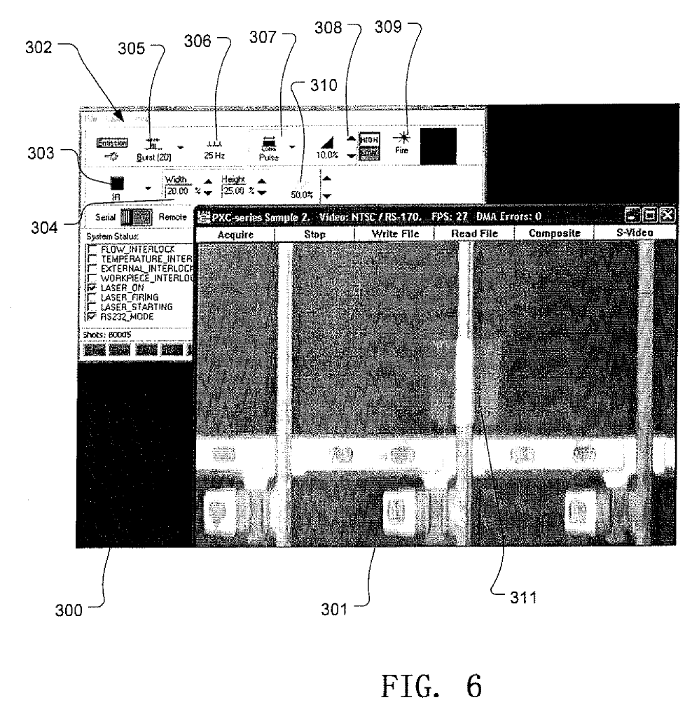

FIG. 6 is an image of a graphical user interface 300 executed by the host computer 165, in the system shown in FIG. 5. The graphical user interface 300 includes the image field 301 generated by the camera 164 under the control of the computer 165. The graphical user interface 300 includes a set 302 of graphical controls for setting the mode of operation of the laser. In the illustrated embodiment, the graphical controls include a wavelength selection button 303, by which wavelength such as the infrared IR output or harmonic outputs of the laser are selected. In addition, tools 304 for setting the width and height of the aperture in the laser and corresponding size of the spot marker 311. A tool 305 is provided for setting the burst count, indicating the number of pulses to be applied. A tool 306 is provided for setting the pulse repetition rate during a burst. A tool 307 is used for selecting the long pulse mode or the short pulse mode. The energy percentage and a high-low adjustment are provided using tool 308. A fire button 309 is provided, to cause the laser to be fired manually in the configured output mode. Tool 310 is provided for setting the intensity of the spot marker 311 on the target. Recipes can be created manually using the interface, and stored and applied automatically to correct defects.

Because of the small size of the traces and pixels and large physical size of an LCD panel, the failure rate for LCD display manufacturing has been relatively high. In order to improve the manufacturing yield for LCD panels, manufacturers have been fixing defects in LCD panels, rather than discarding them. The typical process includes passing all LCD panels three test machine to find the location and classification of defects. The system computer records all the locations and classifications of the defects, and provides the information to the repair machine. The system integrators store commonly used settings, including energy level, long pulse or short pulse mode, wavelength, number of pulses, pulse repetition rate, and aperture size, that are applied for performing certain operations on the defects needed to correct them. The recipes are configured according to the classification of the defect. Many types of repairs can be automatically executed using a computer system and a single laser system as described herein.

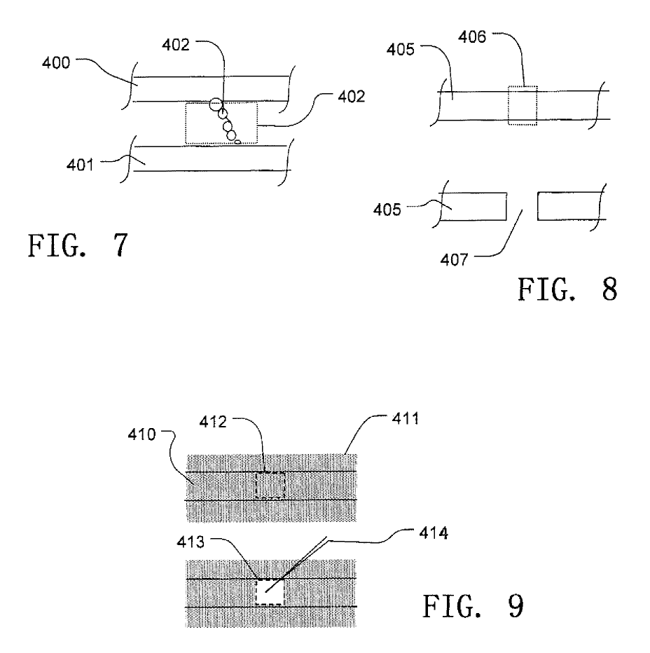

FIGS. 7 through 11A-11B illustrate a variety of the defects for manufacturing operations that can be performed using a multimode laser repair system described herein. In FIG. 7, a short pulse mode is applied to remove a short circuit caused by a residue 402 between traces 400 and 401, which may comprise a variety of conductive trace materials like copper, aluminum, silver, gold, indium tin oxide, molybdenum, and a variety of other conductors and alloys. In operation, the target spot 402 is sized as shown to remove the residue without impacting the traces 400 and 401. The laser pulse setting will vary depending on the objective lens and the material of the residue. For example, a short pulse, green pulse mode can be applied to ablate the material, and open the short circuit.

In FIG. 8, a short pulse mode is applied to cut a trace 405. In operation, the target spot 406 is sized so that it completely crosses the trace 405, the laser mode is set to ablate the trace 405 leaving an opening 407. For example, a typical setting will involve applying about 0.5 mJ of green laser output in 10 pulses. A shutter size of about 20 μ by about 50 μ with a 20× or 50× objective lens.

In FIG. 9, the laser mode is set to remove passivation material from trace 410. The laser target spot 412 is set to define the size of the removed passivation material. A short pulse is applied to ablate the passivation material and open up an access window 413 to the trace 410. A probe 414 can be applied in the window, or other operations executed.

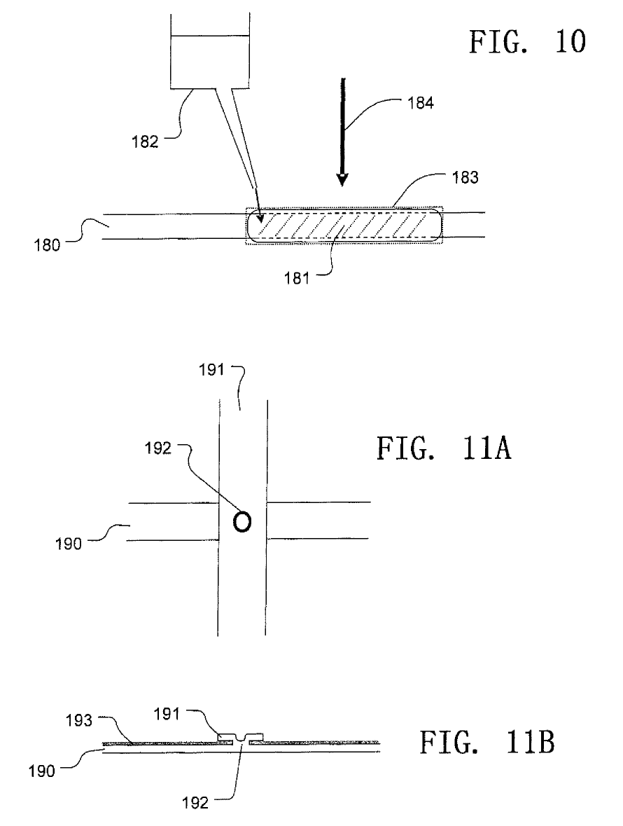

In FIG. 10, a process is illustrated for using a long pulse mode to cure nanoparticle ink used to repair a trace 180, which for context is about 50 μ wide in this example. The trace 180 includes defects 181 that comprise intermittent broken elements causing an open circuit. Nanoparticle ink 182, comprising a mixture of silver particles, solvent and epoxy glue, is applied. The spot marker 183 is sized to cover the ink over the defects 181. A long pulse with relatively low peak energy is applied to cure the ink, without causing ablation or evaporation.

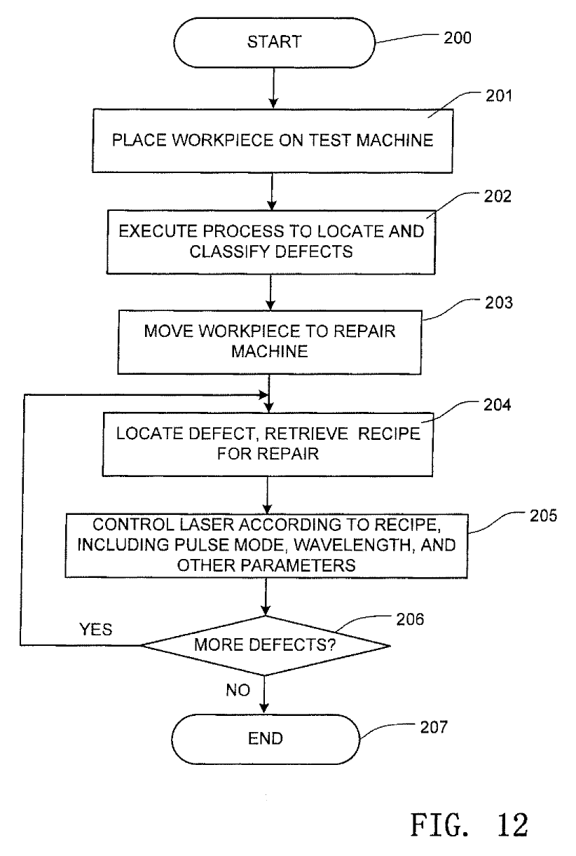

FIGS. 11A and 11B illustrate another process applying a long pulse mode. FIG. 11A is a top view of intersecting traces 190 and 191. FIG. 11B is a cross-sectional view taken along the trace 190. In this process, trace 190 and 191 intersect, with a layer 193 of insulating material therebetween. The multimode laser system is used to connect the traces. The spot marker 192 is set to a size which is slightly less than the width of the traces, and positioned at the intersection. According to a first method, a long pulse infrared output is applied to spot weld the two traces together, melting through the insulating layer 193. In a second method, a short pulse is applied at a selected wavelength to drill a hole through the top trace 191 and expose the lower trace 190. Then a long pulse infrared wavelength is applied to melt the top trace 191 and bond the top trace 191 with the lower trace 190 through the resulting opening.

FIG. 12 is a simplified flow chart of the manufacturing process applying a multimode laser system as described herein. The procedure starts at block 200 with a particular workpiece, such as a LCD panel. The workpiece is placed on a test machine (block 201). The process is executed to locate and classify defects on the panel (block 202). The workpiece is then moved to the repair machine (block 203). The repair machine operates with the information generated using a test machine, to locate a defect and retrieve a recipe for repair (block 204). The repair machine controls the laser according to the recipe, including pulse mode, wavelength, target size and other parameters to execute a repair process (block 205). The process then determines whether there are more defects on the panel at block 206. If there are more defects, then the algorithm loops back to block 204 to locate and repair a next defect. If at block 206 there are no more defects on the panel to be repaired, then the process ends for that panel (block 207).

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A method for manufacturing, comprising:
identifying and classifying targets on a workpiece;
mounting the workpiece on a stage;
controlling a laser to generate pulses of light on a single beam line according to a first pulse mode and a second pulse mode in response to the respective classifications of the targets, the laser operating to deliver pulses having a first pulse width and peak energy in the first pulse mode and having a second pulse width and peak energy in the second pulse mode; and
delivering the pulses of light in the first and second modes on the single beam line through an optical system to the targets on the workpiece.

2. The method of claim 1, wherein the laser includes a resonant cavity including a gain medium, a pump energy source and an optical element that is switchable between a relatively lossless state and a relatively lossy state, so that laser oscillation is prevented in the resonant cavity while the optical element is in the relatively lossy state, and wherein said controlling includes controlling timing of the pump energy source and timing of switching of the optical element between the relatively lossless state and the relatively lossy state.

3. The method of claim 1, wherein the laser includes a resonant cavity including a gain medium, a pump energy source and an optical element that is switchable between a relatively lossless state and a relatively lossy state, so that laser oscillation is prevented in the resonant cavity while the optical element is in the relatively lossy state, and wherein said controlling includes controlling timing of the pump energy source and timing of switching of the optical element between the relatively lossless state and the relatively lossy state, so that
in the first mode the pump energy source is enabled while the optical element is in the lossy state causing energy to be stored in the gain medium, and the optical element is switched to the lossless state thereafter causing a relatively short pulse with a relatively high peak energy, and
in the second mode the pump energy source is enabled and the optical element is switched to the lossless mode before sufficient energy is stored in the gain medium for laser oscillation causing a relatively long pulse with a relatively low peak energy.

4. The method of claim 1, wherein the laser includes a resonant cavity including a gain medium, a pump energy source, and an optical element that is switchable between a relatively lossless state and a relatively lossy state, so that laser oscillation is prevented in the resonant cavity while the optical element is in the relatively lossy state, and said optical system includes a non-linear optic inducing harmonic generation, and optics for selecting an output wavelength from among a fundamental wavelength and a plurality of harmonic wavelengths, and wherein said controlling includes controlling the optics for selecting an output wavelength, and controlling timing of the pump energy source and timing of switching of the optical element between the relatively lossless state and the relatively lossy state.

5. The method of claim 1, including displaying magnified images of spots on the workpiece on a computer workstation, and providing a graphical interface for positioning the spots on said targets, selecting the first mode and the second mode, selecting an output wavelength, selecting a pulse repetition rate, selecting a number of pulses and causing delivery of the pulses to the spots.

6. The method of claim 1, wherein said optical system includes an intra-cavity non-linear optic inducing harmonic generation, and optics for selecting an output wavelength from among a fundamental wavelength and a plurality of harmonic wavelengths, and wherein said controlling includes controlling the optics for selecting an output wavelength.

7. The method of claim 1, wherein said optical system includes a microscope, and wherein said single beam line is directed though the microscope to the target.

8. A laser system for selectively supplying pulses in a plurality of pulse modes along a single beam line comprising:
a laser supplying an output beam, the laser having a resonant cavity comprising a gain medium and a Q-switch, a pump energy source coupled to the gain medium and a Q-switch controller to switch the Q-switch between a relatively lossy state and a relatively lossless state; and
a controller coupled to the pump energy source and the Q-switch controller, which controls timing of the pump energy source and timing of switching of the Q-switch between the relatively lossless state and the relatively lossy state, according to a first mode and a second mode, wherein
in the first mode the pump energy source is enabled while the optical element is in the lossy state causing energy to be stored in the gain medium, and the optical element is switched to the lossless state thereafter causing a relatively short pulse with a relatively high peak energy, and
in the second mode the pump energy source is enabled and the optical element is switched to the lossless mode before sufficient energy is stored in the gain medium for laser oscillation causing a relatively long pulse with a relatively low peak energy;
an optical system for delivering said output beam on a single beam line to a target on a workpiece.

9. The laser system of claim 8, wherein the optical system includes a non-linear optic inducing harmonic generation, and optics for selecting an output wavelength from among a fundamental wavelength and a plurality of harmonic wavelengths, and selectively transmits one or more of the fundamental wavelength and a plurality of harmonic wavelengths along the single beam line, the optical system including a mechanism having at least two settings, each setting causing a different subset of the plurality of wavelengths to be transmitted along the single beam line.

10. The laser system of claim 8, wherein said optical system includes a microscope, and wherein said single beam line is directed though the microscope to the target.

11. The laser system of claim 8, wherein the Q-switch comprises a Pockels cell, and a driver for the Pockels cell which applies a step in voltage to the Pockels cell to switch between the relatively lossless and relatively lossy states, and wherein said controller controls timing of the step in voltage.

12. The laser system of claim 8, wherein the pump energy source comprises a flash lamp, and an electrical power supply coupled to the flash lamp which applies a pulse of power to generate energy to pump the gain medium, and wherein said controller controls timing of the pulse of power.

13. The laser system of claim 8, including a camera arranged to generate a magnified image of the target via the single beam line.

14. The laser system of claim 8, including a camera arranged to generate a magnified image of the target via the single beam line, and a computer including a graphical user interface coupled to the controller which displays the magnified image of the target.

15. A work station for performing laser repair, comprising:
a laser supplying an output beam, the laser having a resonant cavity comprising a solid state gain medium and a Q-switch, a pump energy source coupled to the gain medium and a Q-switch controller to switch the Q-switch between a relatively lossy state and a relatively lossless state; and
an optical system for delivering said output beam on a single beam line to a target on a workpiece, the optical system including a non-linear optic inducing harmonic generation, and optics for selecting an output wavelength from among a fundamental wavelength and a plurality of harmonic wavelengths, and selectively transmits one or more of the fundamental wavelength and a plurality of harmonic wavelengths along the single beam line, and a mechanism having at least two settings, each setting causing a different subset of the plurality of wavelengths to be transmitted along the single beam line;
a camera arranged to generate a magnified image of the target via the single beam line;
a controller coupled to the pump energy source, the Q-switch controller and said mechanism, which controls wavelength selection and timing of the pump energy source, timing of switching of the Q-switch between the relatively lossless state and the relatively lossy state, according to a first mode and a second mode, wherein
in the first mode the pump energy source is enabled while the optical element is in the lossy state causing energy to be stored in the gain medium, and the optical element is switched to the lossless state thereafter causing a relatively short pulse with a relatively high peak energy, and
in the second mode the pump energy source is enabled and the optical element is switched to the lossless mode before sufficient energy is stored in the gain medium for laser oscillation causing a relatively long pulse with a relatively low peak energy; and
a computer coupled to the controller and to the camera, including a graphical user interface coupled to the controller which displays the magnified image of the target, and displays graphical tools for positioning spots on said targets, selecting the first mode and the second mode, selecting an output wavelength, selecting a pulse repetition rate, selecting a number of pulses and causing delivery of the pulses to the spots.
